(19) United States
(12) Patent Application Publication
(10) Pub. No.: US 2016/0216545 A1
(43) Pub. Date: Jul. 28, 2016

(54) LIQUID CRYSTAL DISPLAY

(71) Applicant: Samsung Display Co., Ltd., Yongin-City (KR)

(72) Inventors: Baek Hee LEE, Yongin-si (KR); Nam Seok ROH, Seongnam-si (KR); Hae Il PARK, Seoul (KR)

(21) Appl. No.: 14/736,993

(22) Filed: Jun. 11, 2015

(30) Foreign Application Priority Data
Jan. 28, 2015 (KR) 10-2015-0013367

(51) Int. Cl. G02F 1/1335; G02F 1/1333; G02F 1/1368

(52) U.S. Cl. CPC G02F 1/13362; G02F 1/1368; G02F 1/133377; G02F 1/133528; G02F 2001/133614

(57) ABSTRACT

Provided is a liquid crystal display including: a substrate; a thin film transistor disposed on the substrate; a pixel electrode disposed on the thin film transistor and connected to the thin film transistor; a roof layer disposed on the pixel electrode to be spaced apart from the pixel electrode with a microcavity therebetween; a liquid crystal layer positioned in the microcavity; a polarizer; and a quantum rod layer in which a plurality of quantum rods is disposed, in which one of the polarizer and the quantum rod layer is disposed below the substrate and the other one is disposed on the roof layer.

### CROSS-REFERENCE TO RELATED APPLICATION

This application claims priority to and the benefit of Korean Patent Application No. 10-2015-0013367 filed in the Korean Intellectual Property Office on Jan. 28, 2015, the entire contents of which are incorporated herein by reference.

### BACKGROUND

(a) Technical Field

The present disclosure relates to a liquid crystal display.

(b) Description of the Related Art

A liquid crystal display, which is one of the most common types of flat panel displays currently in use, includes two sheets of display panels with field generating electrodes, such as a pixel electrode and a common electrode, and a liquid crystal layer interposed therebetween.

The liquid crystal display generates an electric field in the liquid crystal layer by applying voltages to the field generating electrodes. By controlling the strength of the generated electric field, the liquid crystal display controls the alignment direction of the liquid crystal molecules of the liquid crystal layer and thereby controls the polarization of incident light to display images.

Generally, two display panels configuring the liquid crystal display may include a thin film transistor array panel and an opposing display panel. In the thin film transistor array panel, a gate line transferring a gate signal and a data line transferring a data signal are formed to cross each other, and a thin film transistor connected with the gate line and the data line, a pixel electrode connected with the thin film transistor, and the like may be formed. In the opposing display panel, a light blocking member, a color filter, a common electrode, and the like may be formed. In some cases, the light blocking member, the color filter, and the common electrode may be formed on the thin film transistor array panel.

In the case of the liquid crystal display in the related art, two sheets of substrates are used, and respective constituent elements are formed on the two sheets of substrates. As a result, the display device is heavy and thick, has a high manufacturing cost, and has a long processing time.

Recently, techniques for manufacturing a liquid crystal display by forming a plurality of microcavities on one substrate and injecting a liquid crystal into the structure have been developed to overcome these shortcomings.

The above information disclosed in this Background section is only for enhancement of understanding of the background of the present disclosure and therefore may contain information that does not form the prior art that is already known in this country to a person of ordinary skill in the art.

### SUMMARY

The present system and method provide a liquid crystal display that includes one substrate and has the advantage of a reduced number of polarizers in the liquid crystal display. An exemplary embodiment of the present system and method provides a liquid crystal display including: a substrate; a thin film transistor disposed on the substrate; a pixel electrode disposed on the thin film transistor and connected to the thin film transistor; a roof layer disposed on the pixel electrode to be spaced apart from the pixel electrode with a microcavity therebetween; a liquid crystal layer positioned in the microcavity; a polarizer; and a quantum rod layer in which a plurality of quantum rods is disposed, in which one of the polarizer and the quantum rod layer is disposed below the substrate and the other one is disposed on the roof layer.

The plurality of quantum rods may convert the light into white light and linear-polarize the light.

The quantum rod layer may be disposed on the roof layer, and the polarizer may be disposed below the substrate.

The quantum rod layer may be a capping layer including the plurality of quantum rods, and the capping layer may be disposed on the roof layer to seal the microcavity.

Light emitted from a light source may pass through the capping layer and then be incident to the liquid crystal layer.

The light may be ultraviolet light or blue light.

Each quantum rod may have an oval shape including a long axis and a short axis or a rod shape.

Each quantum rod may be disposed in a direction in which a long axis thereof is parallel to the surface of the substrate.

A polarization direction of the light linear-polarized by the plurality of quantum rods may be orthogonal to a transmissive axis of the polarizer.

The quantum rod layer may be disposed below the substrate, and the polarizer may be disposed on the roof layer.

Light emitted from a light source may pass through the quantum rod layer and then be incident to the liquid crystal layer.

The liquid crystal display may further include a capping layer disposed between the polarizer and the roof layer to seal the microcavity, in which a polarization direction of the light linear-polarized by the plurality of quantum rods may be orthogonal to a transmissive axis of the polarizer.

According to the exemplary embodiment of the present system and method, in the liquid crystal display including one substrate, since light incident from a light source may be linear-polarized by using a quantum rod, the number of polarizers may be reduced.

Further, since the light incident from a light source is converted into white light by using a quantum rod, color reproducibility may be improved.

### BRIEF DESCRIPTION OF THE DRAWINGS

FIG. 1 is a plan view schematically illustrating a liquid crystal display according to an exemplary embodiment of the present system and method.

FIG. 2 is a plan view illustrating the liquid crystal display according to the exemplary embodiment of the present system and method.

FIG. 3 is a diagram illustrating an example of a cross section taken along line III-III of FIG. 2.

FIG. 4 is a diagram illustrating an example of a cross section taken along line IV-IV of FIG. 2.

FIG. 5 is a diagram illustrating an example of a cross section of a quantum rod according to an exemplary embodiment of the present system and method.

FIGS. 6 and 7 are diagrams illustrating an example of a cross section of a liquid crystal display according to another exemplary embodiment of the present system and method.

### DETAILED DESCRIPTION OF THE EMBODIMENTS

The present system and method are described more fully hereinafter with reference to the accompanying drawings in which exemplary embodiments of the present system and method are illustrated. As those skilled in the art would realize, the described embodiments may be modified in various different ways, all without departing from the spirit or scope of the present system and method.

Accordingly, the drawings and description are illustrative in nature and not restrictive. Like reference numerals designate like elements throughout the specification.

In addition, the size and thickness of each configuration illustrated in the drawings are arbitrarily illustrated for understanding and ease of description, but the present system and method are not limited thereto.

In the drawings, the thicknesses of layers, films, panels, regions, and the like, are exaggerated for clarity. When an element, such as a layer, film, region, or substrate, is referred to as being “on” another element, it may be directly on the other element, or intervening elements may also be present.

In addition, unless explicitly described to the contrary, the word “comprise” and variations such as “comprises” or “comprising”, imply the inclusion of stated elements but not the exclusion of any other elements. Further, throughout the specification, the word “on” means positioning above or below the object portion and does not necessarily mean positioning on the upper side of the object portion based on a gravity direction.

Further, throughout the specification, the word “on a plane” means viewing a target portion from the top, and the word “on a cross section” means viewing a cross section formed by vertically cutting a target portion from the side.

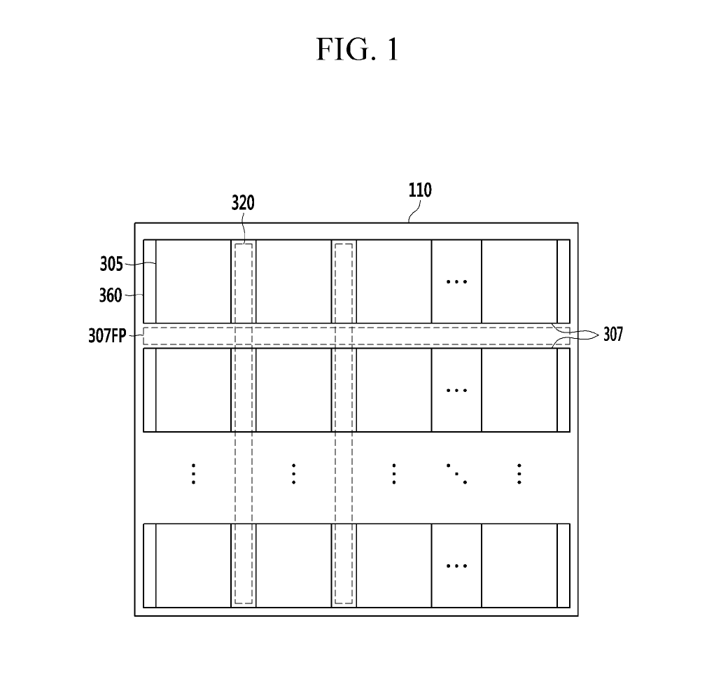

FIG. 1 is a plan view schematically illustrating a liquid crystal display according to an exemplary embodiment of the present system and method.

A liquid crystal display according to the exemplary embodiment of the present system and method includes a substrate 110, which may be made of a material such as glass or plastic. If the substrate 110 is made of plastic, the substrate 110 may be a flexible substrate.

A microcavity 305 covered by a roof layer 360 is disposed on the substrate 110. A plurality of roof layers 360 is disposed on the substrate 110. The roof layers 360 adjacent in a row direction contact each other, and the roof layers 360 adjacent in a column direction are separated from each other. One microcavity 305 is formed below one roof layer 360.

The microcavities 305 may be disposed in a matrix form. A partition wall 320 is positioned between the microcavities 305 adjacent to each other in the row direction. An injection hole formation region (called a trench) 307FP is positioned between the microcavities 305 adjacent to each other in a column direction.

The injection hole formation region 307FP is positioned between the roof layers 360 adjacent in the column direction. The microcavity 305 is not covered, and thus may be exposed, by the roof layer 360 at a portion contacting the injection hole formation region 307FP. This is called an injection hole 307.

The injection holes 307 are formed at both edges of the microcavity 305. The injection hole 307 is formed to expose sides of first and second edges of the microcavity 305, respectively. The side of the first edge and the side of the second edge of the microcavity 305 face each other.

Each roof layer 360 is formed to be separated from the substrate 110 between adjacent partition walls 320 to form the microcavity 305. That is, the roof layer 360 is formed to cover the sides of the microcavity 305 except for the sides of the first edge and the second edge in which the injection holes 307 are formed.

The structure of the liquid crystal display according to the exemplary embodiment of the present system and method described above is just an example, and may be variously modified. For example, a layout form of the microcavities 305, the injection hole formation region 307FP, and the partition walls 320 may be modified, and the plurality of roof layers 360 may be connected to each other in the injection hole formation region 307FP, and a part of each roof layer 360 may be formed to be separated from the substrate 110 in the partition wall 320, and thus, the adjacent microcavities 305 may be connected to each other.

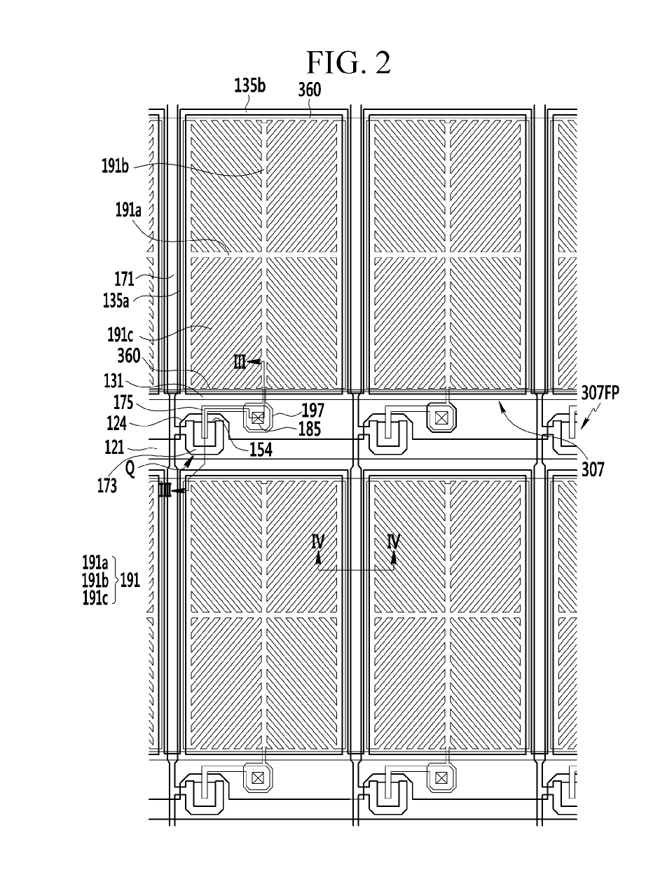

Next, a structure of the liquid crystal display according to an exemplary embodiment of the present system and method is described in detail with reference to FIGS. 2 to 5.

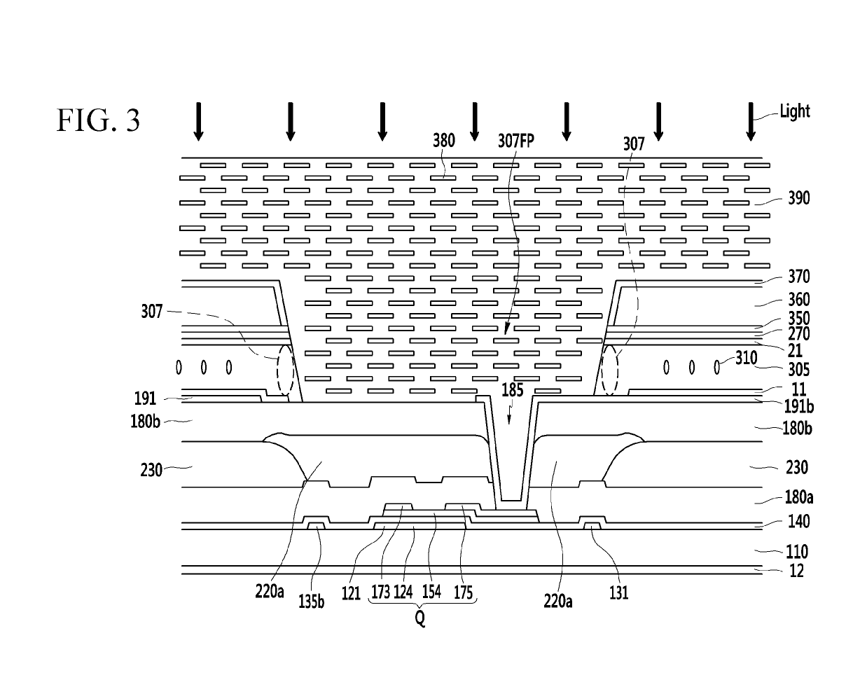

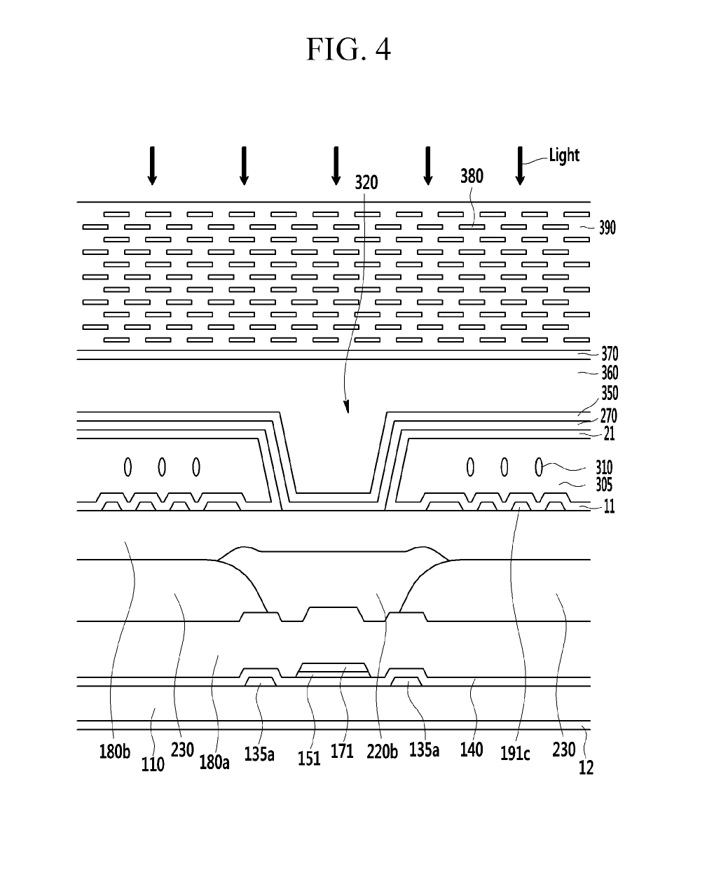

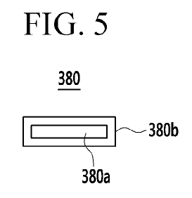

FIG. 2 is a plan view illustrating the liquid crystal display according to an exemplary embodiment of the present system and method. FIG. 3 is a diagram illustrating an example of a cross section taken along line III-III of FIG. 2. FIG. 4 is a diagram illustrating an example of a cross section taken along line IV-IV of FIG. 2. FIG. 5 is a diagram illustrating an example of a cross section of a quantum rod according to an exemplary embodiment of the present system and method.

FIG. 2 illustrates four adjacent pixels among a plurality of pixels disposed in a matrix form.

Referring to FIGS. 2 to 5, a gate line 121 and a storage electrode line 131, which are separated from each other, are disposed on the substrate 110 made of a transparent insulator such as glass or plastic.

The gate line 121 mainly extends in a horizontal direction and transfers a gate signal. The gate line 121 includes a gate electrode 124 protruding from the gate line 121. Here, the protruding form of the gate electrode 124 may be modified.

The storage electrode line 131 mainly extends in a horizontal direction and transfers a predetermined voltage such as a common voltage Vcom. The storage electrode line 131 includes a pair of vertical portions 135a extending to be substantially vertical to the gate line 121, and a horizontal portion 135b connecting ends of the pair of vertical portions 135a to each other. The vertical portions and the horizontal portion 135a and 135b of the storage electrode line 131 may substantially surround a pixel electrode 191, which is described below.

A gate insulating layer 140 is disposed on the gate line 121 and the storage electrode line 131. The gate insulating layer 140 may be made of an inorganic material such as silicon nitride (SiNx) and silicon oxide (SiOx). Further, the gate insulating layer 140 may be formed as a single layer or multilayers.

A semiconductor layer 151 is disposed on the gate insulating layer 140. The semiconductor layer 151 includes a protrusion 154 overlapping with the gate electrode 124.

The semiconductor layers 151 and 154 may be made of amorphous silicon, polycrystalline silicon, metal oxide, and the like.

A data line 171 including a source electrode 173 and a drain electrode 175 are disposed on the semiconductor layer 151.

The data line 171 transfers a data signal and mainly extends in a vertical direction to cross the gate line 121 and the storage electrode line 131. The source electrode 173 protrudes toward the gate electrode 124 and is disposed on the protrusion 154 of the semiconductor layer 151. The drain electrode 175 is separated from the data line 171 and disposed on the protrusion 154 of the semiconductor layer 151. The drain electrode 175 faces the source electrode 173 in a region overlapping the gate electrode 124.

Ohmic contacts (not illustrated) may be disposed between the semiconductor layer 151 and the data line 171 (e.g., between the protrusion 154 of the semiconductor layer 151 and the source electrode 173 and the drain electrode 175) to reduce contact resistance therebetween. In this case, the ohmic contact may be made of silicide or a material, such as n+ hydrogenated amorphous silicon, in which n-type impurity is doped at a high concentration. If the semiconductor layer 151 is made of metal oxide, the ohmic contact may be omitted.

The gate electrode 124, the source electrode 173, the drain electrode 175, and the protrusion 154 of the semiconductor layer 151 together form one thin film transistor Q. A channel of the thin film transistor Q is formed in the protrusion 154 of the semiconductor layer 151 between the source electrode 173 and the drain electrode 175.

A first interlayer insulating layer 180a is disposed on the data line 171, the drain electrode 175, the protrusion 154 of the semiconductor layer 151 between the source electrode 173 and the drain electrode 175, and the gate insulating layer 140. The first gate insulating layer 180a may be made of an inorganic material such as silicon nitride (SiNx) and silicon oxide (SiOx).

A color filter 230, a horizontal light blocking member 220a, and a vertical light blocking member 220b are disposed on the first interlayer insulating layer 180a.

The horizontal light blocking member 220a is disposed in a direction parallel with the gate line 121, and the vertical light blocking member 220b is disposed in a direction parallel with the data line 171. The horizontal light blocking member 220a and the vertical light blocking member 220b are connected to each other to form a lattice structure having an opening corresponding to an area displaying an image, and include a material that does not transmit light. In another embodiment, the horizontal light blocking member 220a and the vertical light blocking member 220b may be formed on an upper insulating layer 370, which is described below.

The color filter 230 is disposed in the opening formed by the horizontal light blocking member 220a and the vertical light blocking member 220b, and may display one of the primary colors such as three primary colors of red, green, and blue. However, the color filter 230 is not limited to displaying the three primary colors of red, green and blue, but may display one of cyan, magenta, yellow, and white-based colors. The color filter 230 may include a material displaying the same color for pixels that are adjacent in the horizontal direction, and include a material displaying different colors for pixels that are adjacent in the vertical direction.

A second interlayer insulating layer 180b is disposed on and covers the color filter 230, the horizontal light blocking member 220a, and the vertical light blocking member 220b. The second interlayer insulating layer 180b may include an inorganic material, such as silicon nitride (SiNx) and silicon oxide (SiOx), or an organic material. When a step is generated due to a difference in thicknesses among the color filter 230, the horizontal light blocking member 220a, and the vertical light blocking member 220b, the second interlayer insulating layer 180b including the organic material reduces or removes the effects of the step.

A contact hole 185 exposing the drain electrode 175 is formed in the horizontal light blocking member 220a, and the first and second interlayer insulating layers 180a and 180b.

The pixel electrode 191 is disposed on the second interlayer insulating layer 180b. The pixel electrode 191 may be made of a transparent conductive material such as indium tin oxide (ITO) and indium zinc oxide (IZO).

An overall shape of the pixel electrode 191 may be substantially a quadrangle. The pixel electrode 191 includes a cross stem configured by a horizontal stem 191a and a vertical stem 191b crossing the horizontal stem 191a. The pixel electrode 191 is divided into four domains by the horizontal stem 191a and the vertical stem 191b, and each domain includes a plurality of minute branches 191c. Further, the pixel electrode 191 may further include an outer stem surrounding an outside of the pixel electrode 191.

The minute branch 191c of the pixel electrode 191 forms an angle of approximately 40° to 45° with the gate line 121 or the horizontal stem 191a. The minute branches 191c of two adjacent domains may be perpendicular to each other. Further, widths of the minute branches 191 may be gradually increased, or distances between the minute branches 191c may be different from each other.

The pixel electrode 191 includes an extension 197 that is connected to a lower end of the vertical stem 191b and wider than the vertical stem 191b. The pixel electrode 191 is physically and electrically connected to the drain electrode 175 through the contact hole 185 in the extension 197, and receives a data voltage from the drain electrode 175.

The description of the thin film transistor Q and the pixel electrode 191 described above are just examples. The structure of the thin film transistor and the design of the pixel electrode may be modified in various ways, such as to improve side visibility.

A common electrode 270 is disposed on but spaced apart from the pixel electrode at a predetermined distance by the microcavity 305. That is, the microcavity 305 is disposed between the pixel electrode 191 and the common electrode 270 and surrounded by the pixel electrode 191 and the common electrode 270. The common electrode 270 is disposed in the row direction, and formed on the microcavity 305 and the partition wall 320 portion. As FIG. 4 shows, the common electrode 270 is disposed to cover an upper surface and a side of the microcavity 305.

The common electrode 270 may be made of a transparent metal material such as indium tin oxide (ITO) and indium zinc oxide (IZO). When the common voltage is applied to the common electrode 270, and the data voltage is applied to the pixel electrode 191, an electric field is generated between the common electrode 270 and the pixel electrode 191.

Further, the present system and method are not limited thereto, and the common electrode 270 may be disposed with the pixel electrode 191 and an insulating layer therebetween. In this case, a horizontal field is formed between the common electrode 270 and the pixel electrode 191, and the microcavity 305 may be disposed on the common electrode 270.

A lower alignment layer 11 and an upper alignment layer 21 are disposed on the pixel electrode 191 and below the common electrode 270, respectively.

The lower alignment layer 11 and the upper alignment layer 21 may be vertical alignment layers. The lower alignment layer 11 and the upper alignment layer 21 may include one or more materials generally used as a liquid crystal alignment layer, such as polyamic acid, polysiloxane, or polyimide. The lower alignment layer 11 and the upper alignment layer 21 may be connected to each other on the side wall of the edge of the microcavity 305.

The microcavity 305 has an injection hole 307 for injecting a liquid crystal material including liquid crystal molecules 310. A liquid crystal layer including the liquid crystal molecules 310 is disposed in the microcavity 305. The liquid crystal molecules 310 may have negative dielectric anisotropy, which means the liquid crystal molecules may stand up in a vertical direction to the substrate 110 when the electric field is not applied. That is, the liquid crystal molecules 310 may be vertically aligned. The liquid crystal material may be injected into the microcavity 305 through the injection hole 307 by using capillary force. An alignment material for forming the lower and upper alignment layers 11 and 21 may also be injected into the microcavity 305 through the injection hole 307 before the liquid crystal material is injected. The width and area of the microcavity 305 may be variously modified according to the size and resolution of the display device. That is, the microcavity 305 may be formed in one pixel area, two adjacent pixel areas, or over the plurality of pixel areas.

In the exemplary embodiment described above, the injection holes 307 are formed at the edges of microcavities 305 adjacent in the vertical direction that face each other. However, in another embodiment, the injection hole may be formed in only one of the two edges facing each other.

A plurality of microcavities 305 is formed in a matrix form. The microcavities 305 adjacent in the horizontal direction (x-axial direction) may be separated by the partition wall 320, and the microcavities 305 adjacent in the vertical direction (y-axial direction) may be separated by the injection hole formation region 307FP. In other words, one microcavity 305 may be disposed in a region that is defined by adjacent partition walls 320 and adjacent injection hole formation regions 307FP. The injection hole formation region 307FP includes the vicinity of the injection hole 307 corresponding to the outside of the microcavity 305.

A lower insulating layer 350 is disposed on the common electrode 270. The lower insulating layer 350 may be formed of an inorganic material such as silicon nitride (SiNx) or silicon oxide (SiOx).

A roof layer 360 is disposed on the lower insulating layer 350. The roof layer 360 serves to support the microcavity 305, which is a space between the pixel electrode 191 and the common electrode 270. The roof layer 360 may include a photoresist or other organic materials. Further, the roof layer 360 may be formed by a color filter.

The partition wall 320 is positioned between the microcavities 305 adjacent in the horizontal direction, and formed as part of the lower insulating layer 350, the common electrode 270, and the roof layer 360. The partition walls 320 may be disposed in an extending direction of the data line 171. Even though the substrate 110 may be bent by the partition walls 320, the generated stress is small, and a degree of change in a cell gap may be significantly reduced.

The upper insulating layer 370 is disposed on the roof layer 360. The upper insulating layer 370 may contact an upper surface of the roof layer 360. The upper insulating layer 370 may be made of an inorganic material such as silicon nitride (SiNx) and silicon oxide (SiOx). The upper insulating layer 370 serves to protect the roof layer 360, which may be made of an organic material, but may be omitted in some cases.

A capping layer 390 is disposed on the upper insulating layer 370 and in the injection hole formation region 307FP corresponding to a space between two microcavities 305 adjacent in the vertical direction, thereby covering the injection hole 307 of the microcavity 305 exposed by the injection hole formation region 307FP. That is, the capping layer 390 may seal the microcavity 305 so as to prevent the liquid crystal molecules 310 formed in the microcavity 305 from being discharged to the outside.

The capping layer 390 may be formed by coating and curing a liquid material for forming the capping layer. The capping layer 390 may include an organic material or an inorganic material. When the upper insulating layer 370 does not exist, the capping layer 390 is positioned on the roof layer 360.

The capping layer 390 may be formed as multilayers such as a double layer and a triple layer. The double layer is configured by two layers made of different materials. The triple layer is configured by three layers in which materials of adjacent layers are different from each other. For example, the capping layer 390 may include a layer made of an organic material and a layer made of an inorganic material.

According to one embodiment, the capping layer 390 includes a plurality of quantum rods 380. That is, the quantum rods 380 are included in the capping layer 390. The quantum rod 380 may have an oval shape having a long axis and a short axis or a rod shape. The quantum rods 380 may exist throughout the capping layer 390, including on the upper insulating layer 370 and the injection hole formation region 307FP including the periphery of the injection hole 307.

Referring to FIG. 5, the quantum rod 380 includes a core 380a forming a center and a shell 380b covering the core 380a. The core 380a may have an oval shape or a rod shape. The core 380a may include one or more materials selected from a group consisting of CdSe, CdS, CdTe, ZnS, ZnSe, ZnTe, CdSeTe, CdZnS, CdSeS, PbSe, PbS, PbTe, AgInZnS, HgS, HgSe, HgTe, GaN, GaP, GaAs, InP, InZnP, InGaP, InGaN InAs, and ZnO. The shell 380b may include one or more materials selected from a group consisting of CdS, CdSe, CdTe, CdO, ZnS, ZnSe, ZnTe, ZnO, InP, InS, GaP, GaN, GaO, InZnP, InGaP, InGaN, InZnSCdSe, PbS, TiO, SrSe, and HgSe.

According to one embodiment, the quantum rod 380 is disposed so that a long axis thereof is parallel with the surface of the substrate 110. The quantum rod 380 and the liquid material for forming the capping layer may be mixed to be coated and then cured on the upper insulating layer 370 to form the capping layer 390 including the quantum rod 380. As an example, the long axes of the quantum rods 380 may be arranged in parallel with the surface of the substrate 110 by forming an uneven layer on the upper insulating layer 370. As another example, the quantum rod 380 and the liquid material for forming the capping layer may be mixed to be coated and rubbed on the upper insulating layer 370 and cured after the long axes of the quantum rods 380 are arranged in parallel with the surface of the substrate 110. As another example, the quantum rod 380 and the liquid material for forming the capping layer may be mixed to be coated on the upper insulating layer 370 and cured after the long axes of the quantum rods 380 are arranged in parallel with the surface of the substrate 110 by applying a voltage.

As FIGS. 3 and 4 show, light emitted from a light source (not illustrated) is incident to an upper surface of the capping layer 390. The incident light is converted into white light in the capping layer 390, and the white light is emitted through the bottom of the capping layer 390. Here, the light emitted from the light source may be ultraviolet light or blue light.

When the ultraviolet light is incident to the capping layer 390 from the light source, the ultraviolet light is incident to the plurality of quantum rods 380 disposed inside the capping layer 390. As a result of the incident ultraviolet light, the plurality of quantum rods 380 emit red light, green light, and blue light, which combine to form white, linear-polarized light that is emitted toward the liquid crystal layer positioned below the capping layer 390.

Further, when the blue light is incident to the capping layer 390 from the light source, the blue light is incident to the plurality of quantum rods 380 disposed inside the capping layer 390. As a result of the incident blue light, the plurality of quantum rods 380 emit red light and green light. The combination of the incident blue light, the emitted red light, and the emitted green light results in a white, linear-polarized light being emitted toward the liquid crystal layer positioned below the capping layer 390.

A polarizer 12 is disposed on a lower surface of the substrate 110. A polarization direction of the light linear-polarized by the quantum rods 380 inside the capping layer 390 may be orthogonal to a transmissive axis of the polarizer 12.

As such, since the plurality of quantum rods 380 disposed inside the capping layer 390 serves as a polarizer that linear-polarizes the light incident from the light source, the liquid crystal display according to the above-described exemplary embodiment requires only one polarizer.

Further, the white light emitted by the quantum rods 380 improves color reproducibility.

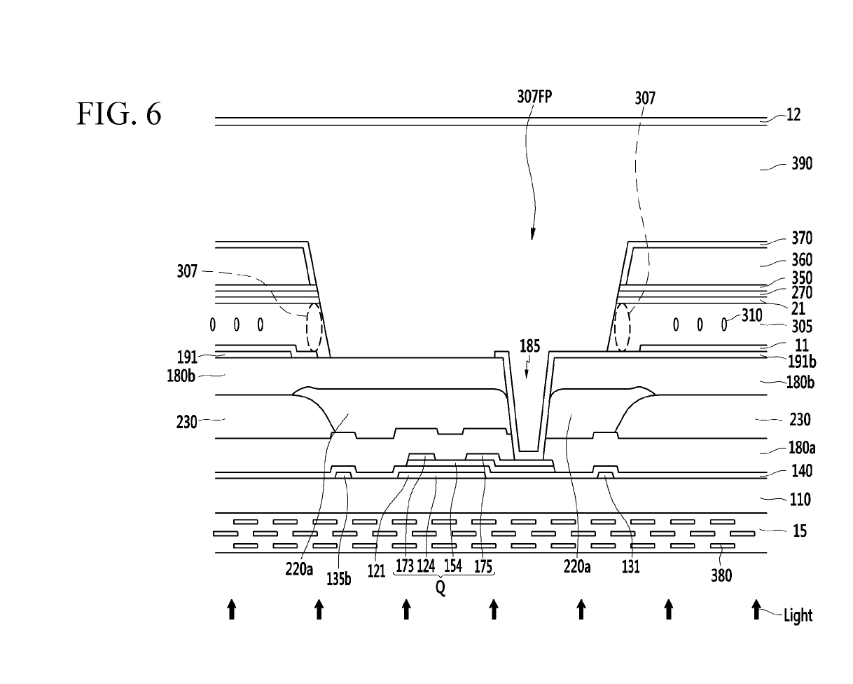

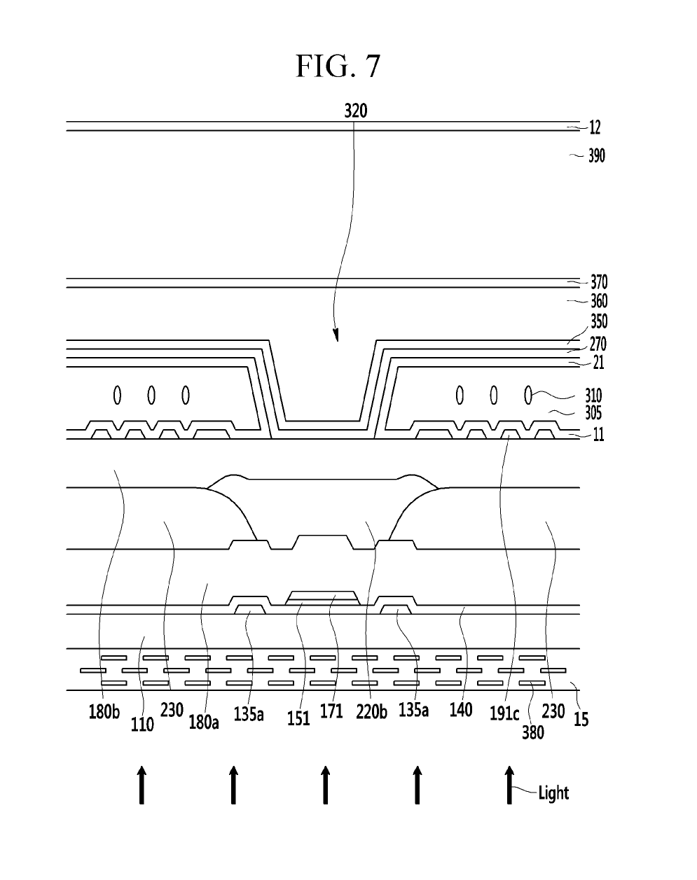

In another exemplary embodiment, the layout of the quantum rods 380 and the polarizer 12 may be changed. A liquid crystal display according to another exemplary embodiment of the present system and method is described with reference to FIGS. 6 and 7.

FIGS. 6 and 7 are diagrams illustrating an example of a cross section of a liquid crystal display according to another exemplary embodiment of the present system and method. When the liquid crystal display according to the exemplary embodiment of FIGS. 6 and 7 is compared with the liquid crystal display in FIG. 2, the layouts of the quantum rods 380 and the polarizer 12 are opposite to each other, while the remaining structures are the same as each other. Accordingly, descriptions of the same structures are omitted.

A polarization layer 15 is disposed below the substrate 110. The polarization layer 15 includes a photosensitive resin and a plurality of quantum rods 380. That is, the plurality of quantum rods 380 is included inside the polarization layer 15. Each quantum rod 380 may have an oval shape having a long axis and a short axis or a rod shape.

According to the embodiment of FIGS. 6 and 7, the quantum rod 380 is disposed so that a long axis thereof is parallel with the surface of the substrate 110. The quantum rods 380 and the photosensitive resin may be mixed, coated and then cured below the substrate 110 to form the polarization layer 15 including the quantum rods 380. As an example, the long axes of the quantum rods 380 may be arranged in parallel with the surface of the substrate 110 by forming an uneven layer between the substrate 110 and the polarization layer 15. As another example, the quantum rod 380 and the photosensitive resin may be mixed to be coated and rubbed below the substrate 110 and cured after the long axes of the quantum rods 380 are arranged in parallel with the surface of the substrate 110. As another example, the quantum rod 380 and the photosensitive resin may be mixed to be coated below the substrate 110 and cured after the long axes of the quantum rods 380 are arranged in parallel with the surface of the substrate 110 by applying a voltage.

As FIGS. 6 and 7 show, light emitted from a light source (not illustrated) is incident to the polarization layer 15. The incident light is converted into white light in the polarization layer 15, and the white light is emitted through the top of the polarization layer 15. Here, the light emitted from the light source may be ultraviolet light or blue light.

When the ultraviolet light is incident to the polarization layer 15 from the light source, the ultraviolet light is incident to the plurality of quantum rods 380 disposed inside the polarization layer 15. As a result of the incident ultraviolet light, the plurality of quantum rods 380 emit red light, green light, and blue light, which combine to form white, linear-polarized light that is emitted toward the liquid crystal layer positioned on the polarization layer 15.

Further, when the blue light is incident to the polarization layer 15 from the light source, the blue light is incident to the plurality of quantum rods 380 disposed inside the polarization layer 15. As a result of the incident blue light, the plurality of quantum rods 380 emit red light and green light. The combination of the incident blue light, the emitted red light, and the emitted green light results in a white, linear-polarized light being emitted toward the liquid crystal layer positioned on the polarization layer 15.

A polarizer 12 is disposed on the capping layer 390. A polarization direction of the light linear-polarized by the quantum rods 380 inside the polarization layer 15 may be orthogonal to a transmissive axis of the polarizer 12.

In another embodiment, the polarization layer 15 may be disposed on the capping layer 390, and the polarizer 12 may be disposed below the substrate 110. In this case, the light emitted from the light source is incident to the polarization layer 15 and then incident to the liquid crystal layer disposed below the polarization layer 15.

Here, the polarization layer 15 including the plurality of quantum rods and the capping layer 390 including the plurality of quantum rods of the liquid crystal display according to the exemplary embodiment in FIG. 2 may be referred to as a quantum rod layer.

While the present system and method have been described in connection with exemplary embodiments, the present system and method are not limited to the disclosed embodiments. On the contrary, the present system and method cover various modifications and equivalent arrangements included within the spirit and scope of the appended claims.

<Description of symbols>

| | |
|---|---|
| 12: Polarizer | 15: Polarization layer |
| 110: Substrate | 121: Gate line |
| 124: Gate electrode | 151: Semiconductor layer |
| 171: Data line | 173: Source electrode |
| 175: Drain electrode | 191: Pixel electrode |

| | |
|---|---|
| 270: Common electrode | 305: Microcavity |

| | |
|---|---|
| 307: Injection hole | 307FP: Injection hole formation region |
| 310: Liquid crystal molecule | 320: Partition wall |
| 360: Roof layer | 380: Quantum rod |
| 390: Capping layer | |

What is claimed is:

1. A liquid crystal display comprising:
a substrate;
a thin film transistor disposed on the substrate;
a pixel electrode disposed on the thin film transistor and connected to the thin film transistor;
a roof layer disposed on the pixel electrode to be spaced apart from the pixel electrode with a microcavity therebetween;
a liquid crystal layer positioned in the microcavity;
a polarizer; and
a quantum rod layer in which a plurality of quantum rods is disposed,
wherein one of the polarizer and the quantum rod layer is disposed below the substrate and the other one is disposed on the roof layer.

2. The liquid crystal display of claim 1, wherein the plurality of quantum rods converts the light into white light and linear-polarizes the light.

3. The liquid crystal display of claim 2, wherein the quantum rod layer is disposed on the roof layer, and
the polarizer is disposed below the substrate.

4. The liquid crystal display of claim 3, wherein the quantum rod layer is a capping layer including the plurality of quantum rods, and
the capping layer is disposed on the roof layer to seal the microcavity.

5. The liquid crystal display of claim 4, wherein light emitted from a light source passes through the capping layer to be incident to the liquid crystal layer.

6. The liquid crystal display of claim 5, wherein the light is ultraviolet light or blue light.

7. The liquid crystal display of claim 6, wherein each quantum rod has an oval shape including a long axis and a short axis or a rod shape.

8. The liquid crystal display of claim 7, wherein each quantum rod is disposed in a direction in which a long axis thereof is parallel to a surface of the substrate.

9. The liquid crystal display of claim 8, wherein a polarization direction of the light linear-polarized by the plurality of quantum rods is orthogonal to a transmissive axis of the polarizer.

10. The liquid crystal display of claim 2, wherein the quantum rod layer is disposed below the substrate, and
the polarizer is disposed on the roof layer.

11. The liquid crystal display of claim 10, wherein light emitted from a light source passes through the quantum rod layer and then is incident to the liquid crystal layer.

12. The liquid crystal display of claim 11, wherein the light is ultraviolet light or blue light.

13. The liquid crystal display of claim 12, wherein each quantum rod has an oval shape including a long axis and a short axis or a rod shape.

14. The liquid crystal display of claim 13, wherein each quantum rod is disposed in a direction in which a long axis thereof is parallel to a surface of the substrate.

15. The liquid crystal display of claim 14, further comprising a capping layer disposed between the polarizer and the roof layer to seal the microcavity,
wherein a polarization direction of the light linear-polarized by the plurality of quantum rods is orthogonal to a transmissive axis of the polarizer.
